(19) United States
(12) Patent Application Publication
(10) Pub. No.: US 2002/0021468 A1
(43) Pub. Date: Feb. 21, 2002

(54) Semiconductor integrated circuit having receiving and transmitting units formed on a single semiconductor chip with a test signal input port

(76) Inventors: Takahiro Kato, Ome (JP); Satoshi Ueno, Ome (JP); Keiki Watanabe, Tachikawa (JP); Atsushi Takai, Koganei (JP)

Correspondence Address: MATTINGLY, STANGER & MALUR, P.C., 1800 DIAGONAL ROAD, SUITE 370, ALEXANDRIA, VA, 22314, US

(21) Appl. No.: 09/924,589

(22) Filed: Aug. 9, 2001

(30) Foreign Application Priority Data
Aug. 10, 2000 (JP) 2000-242618

(51) Int. Cl. G02B 6/12; H04B 10/00

(52) U.S. Cl. 359/152; 385/14

(57) ABSTRACT

A semiconductor integrated circuit having, formed on a single semiconductor chip, a receiving circuit unit for separating a multiplex signal from outside into signals on a plurality of channels, supplying them to outside, and generating a clock signal from the input signal, a loopback path for taking out, by branching, the signals separated by the receiving circuit unit, a selector for receiving input channel signals from the outside, receiving the separated channel signals from the receiving circuit unit via the loopback path, and selecting either the channel signals from the outside or the channel signals from the loopback path responsive to a test mode signal, and a transmitting circuit unit for multiplexing the output from the selector in a time sharing manner and supplying the multiplex signal to the outside.

### BACKGROUND OF THE INVENTION

The present invention generally relates to a semiconductor device provided on an optical communication module for communicating over an optical transmission path, and particularly to technology useful for testing the above-given semiconductor device and optical communication module by feeding an electrical signal from the receiving side back to the transmitting side via a loopback path.

In optical communication, a plurality of channels of low speed electric signals are generally multiplexed into a single channel of high speed electric signals, and converted into an optical signal so as to be transmitted through an optical transmission path. Also, an optical communication module is used for the multiplexing and the conversion between the optical and electric signals.

In recent years, optical communication networks have been rapidly expanded, and the high-density integration of the optical communication module is being advanced toward low cost, high quality optical communication.

FIGS. 1A and 1B are block diagrams schematically showing the circuit arrangements of conventional optical communication modules. An optical communication module 10 shown in FIG. 1A has an opto-electrical conversion unit 20, a signal reception IC 110, a signal transmission IC 120 and an electro-optical conversion unit 40. The opto-electrical conversion unit 20 includes a photodiode by which a multiplexed optical input signal transmitted from the optical communication apparatus of another station is converted into a multiplexed electric input signal, and a preamplifier for amplifying the electric input signal. The signal reception IC 110 has a signal reception process circuit 130 including a demultiplexer for separating the multiplexed input electric signal into the respective channel signals. The signal transmission IC 120 has a signal transmission process circuit 150 including a multiplexer by which the externally supplied plurality of channel signals are multiplexed in a time sharing manner. The electro-optical conversion unit 40 includes a laser diode by which the multiplexed electric signal from the transmission IC 120 is converted into an optical signal, and an LD driver for driving the laser diode. The reception IC 120 and the transmission IC 110 of the communication module are implemented with separate IC chips. Namely, since the conventional IC for the optical communication utilizing silicon bipolar transistors operates with a large electric current flowing therein for a high frequency operation, which results in a large heat dissipation of the IC. Therefore, it is conventionally necessary to prepare a signal transmission IC and a signal reception IC with separate chips, thereby suppressing electric power consumption and heat dissipation per chip.

In an optical communication system including two stations each having an optical communication module similar to the module 10 installed, the module 10 of one station receives at its external input terminal an optically multiplexed signal, as an optical input signal Ip, that is transmitted from the module 10 of the other station via an optical fiber. The optical input signal Ip is supplied to the opto-electrical conversion unit 20, converted into an electrical signal by the photodiode, and amplified by the preamplifier, thus arriving at the input terminal of the reception IC 110. The reception IC 110 demultiplexes the electrical signal into a plurality of channel signals which appear as electric output signals Oic to, for example, the following communication apparatus.

When the one station transmits, electric input signals Iic on a plurality of channels are multiplexed by the transmission IC 120, and converted by the electro-optical conversion unit 40 into an optical signal which is then fed to the optical fiber as an optical output signal Op.

The operation test of these optical communication modules and the intensity adjustment for the optical signal transmitted and received between the stations are performed on the basis of the observation of the correlation between the optical input signal Ip from the optical fiber and the electric output signal Oic from the reception IC 110, and the correlation between the electric input signal Iic to the transmission IC 120 and the optical output signal Op to the optical fiber.

When the optical communication system once established is tested and adjusted according to the above method, however, it is necessary to disassemble the apparatus and connect a certain test equipment at a predetermined place. Therefore, this method is impractical because of much time consumption and piling up of expenses.

Thus, as shown in FIG. 1B, a technique is proposed that uses a loopback path 170 provided between the transmission IC 120 and the reception IC 110 so that the output signal from the reception IC 110 is fed back to the transmission IC 120 via the loopback path 170 (see JP-A-8-213951 laid open Aug. 20, 1996). This enables the test/adjustment of the optical communication modules only by observing the correlation between the optical input signal Ip from the optical fiber and the optical output signal Op to the optical fiber.

This technique using the loopback path 170 in order to make the test/adjustment of the optical communication modules, however, has the difficulty in the wiring design and board production. For example, the loopback paths 170 corresponding to the channel number are required to provide between different IC chips, and the crosstalk between the wiring conductors and the difference between the signal delays caused when the signal currents flow in the wiring conductors must be reduced to a constant value or below.

In addition, as illustrated in FIG. 1B, a buffer IC 60 for loopback is sometimes provided on the loopback path 170 in order to adjust the signal deformation and delay caused on the path 170. When the module is tested on the path using this circuit, the electric signal may be affected by the buffer IC 60 as it passes through the buffer IC 60 unless the buffer IC 60 is designed to enable the same fast operation as the transmission IC 120 and reception IC 110 are designed to assure fast operation enough for optical communication. Thus, the test result cannot be considered as correctly reflecting the performance of the module. Also, because the buffer IC for loopback is produced as, for example, ASIC (Application Specified IC), and cannot be guaranteed to make the same fast operation as the transmission IC 120 and reception IC 110, the test result does not reflect only the performance of the optical communication module.

Moreover, in the case of designing the buffer IC 60 for loopback, the interface specification for the buffer IC 60 must be matched to the output interface specification for the reception IC 110 and to the input interface specification for the transmission IC 120, thus the design being complicated.

### SUMMARY OF THE INVENTION

It is an object of the invention to provide a semiconductor integrated circuit, such as a semiconductor integrated circuit including a transceiver or the like to be mounted on an optical communication module, of which the operation can be tested without using a discrete component such as a loopback IC.

It is another object of the invention to provide an optical communication module of which the operation can be tested without using such a discrete component that is not used in the normal communication operation but used only at the time of testing, or under the condition in which only a component (IC device) that is to be used in the normal communication operation is operated, and of which the design can be easily made.

The semiconductor integrated circuits according embodiments of the present invention described below may be implemented by use of, for example, a bipolar transistor structure consuming a low power, reported in “1998 IEEE International Solid-State Circuits Conference”, pp. 312-313.

According to main features of the invention, in a transceiver or the like that has a receiving circuit unit by which a multiplex electrical input signal is demultiplexed into a plurality of channel signals and produced to the outside, and a transmitting circuit unit by which a plurality of electrical input signals on a plurality of channels are multiplexed in a time sharing manner to generate a multiplex electrical output signal, at least the receiving circuit unit and transmitting circuit unit are formed by use of low power consumption semiconductor devices, and implemented in a single semiconductor chip, so that the operation of the circuits can be easily tested without using any discrete components.

According to one aspect of the invention, there is provided a semiconductor integrated circuit comprising:

a receiving circuit unit for separating a multiplex electrical input signal from a first input port into electrical channel signals on a plurality of channels, delivering the separated electrical channel signals to a first output port, and generating a clock signal from the multiplex electrical input signal;

a loopback path for taking out part of each of the separated electrical channel signals from the receiving circuit unit;

a selector for receiving each of the separated electrical channel signals via the loopback path and a plurality of input electrical channel signals fed from a second input port, and selecting the separated electrical channel signals from the second input port or the input electrical channel signals from the loopback path depending on a test mode signal fed from a switch port; and

a transmitting circuit unit for multiplexing an output from the selector in a time sharing manner to produce a multiplex electrical output signal, and delivering the output signal to a second output port, the receiving circuit unit, the loopback path, the selector and the transmitting circuit unit being formed on a single semiconductor chip, whereby the semiconductor integrated circuit can be tested in a test mode.

According to another aspect of the invention, there is provided a semiconductor integrated circuit having a transceiver comprising:

a first input port for receiving a multiplex electrical input signal;

a plurality of second input ports for receiving a plurality of electrical data input signals;

a switch port for receiving a test mode signal;

a receiving circuit unit having a function to separate the multiplex electrical input signal received via the first input port to produce a plurality of data signals;

a plurality of first output ports for delivering the plurality of data signals produced from the receiving circuit unit;

a loopback path with one end coupled to an output of the receiving circuit unit;

a selector arranged to be controlled by the test mode signal fed via the switch port, to receive the plurality of electrical data input signals via the plurality of second input ports, to be connected to another end of the loopback path to receive the plurality of data signals generated from the receiving circuit unit, to normally select the plurality of electrical data input signals from the plurality of second input ports, and when receiving the test mode signal via the switch port, to select the plurality of data signals generated from the receiving circuit unit;

a transmitting circuit unit having a function to multiplex electrical data signals selected by the selector to produce a multiplex electrical output signal; and

a second output port for delivering the multiplex electrical output signal generated from the transmitting circuit unit, the first input port, the plurality of second input ports, the switch port, the receiving circuit unit, the plurality of first output ports, the loopback path, the selector, the transmitting circuit unit and the second output port being formed on a single semiconductor chip, whereby the transceiver can be tested in a test mode.

### BRIEF DESCRIPTION OF THE DRAWINGS

FIGS. 1A and 1B are block diagrams showing the schematic structures of a conventional optical communication module and the operation test enabled modification of the module.

FIG. 2 is a block diagram showing the schematic structure of a transceiver IC for optical communication according to one embodiment of the invention.

FIG. 3 is a block diagram showing the schematic structure of an optical communication module according to the embodiment of the invention.

FIG. 4 is a block diagram showing an arrangement for testing the operation of the transceiver IC shown in FIG. 2.

FIG. 5 is a block diagram showing an arrangement for testing the operation of the optical communication module shown in FIG. 3.

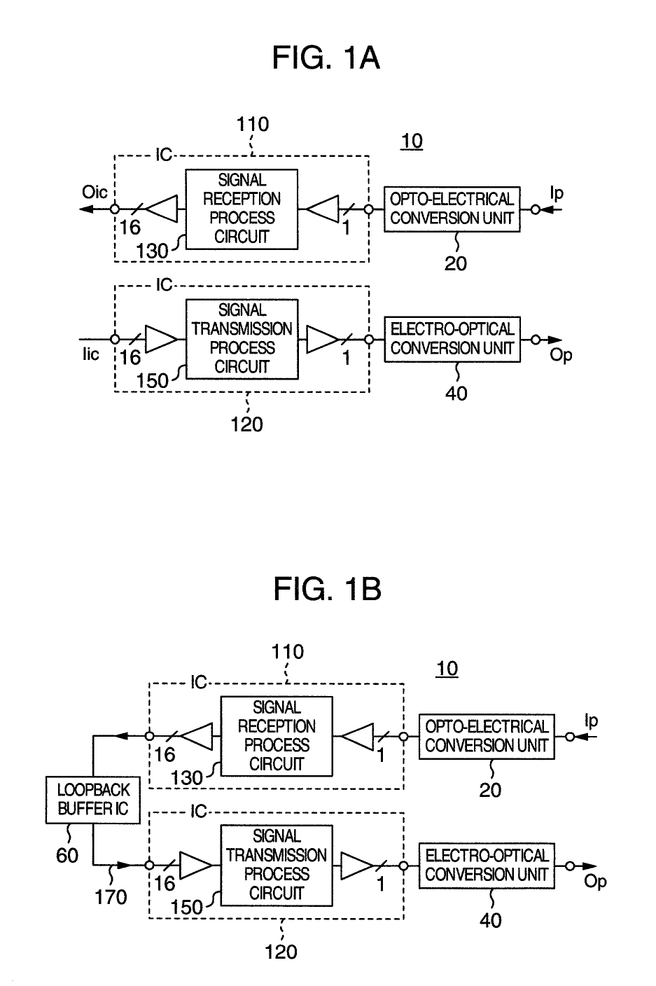

### DESCRIPTION OF THE EMBODIMENTS

An embodiment of the invention will be described with reference to the accompanying drawings.

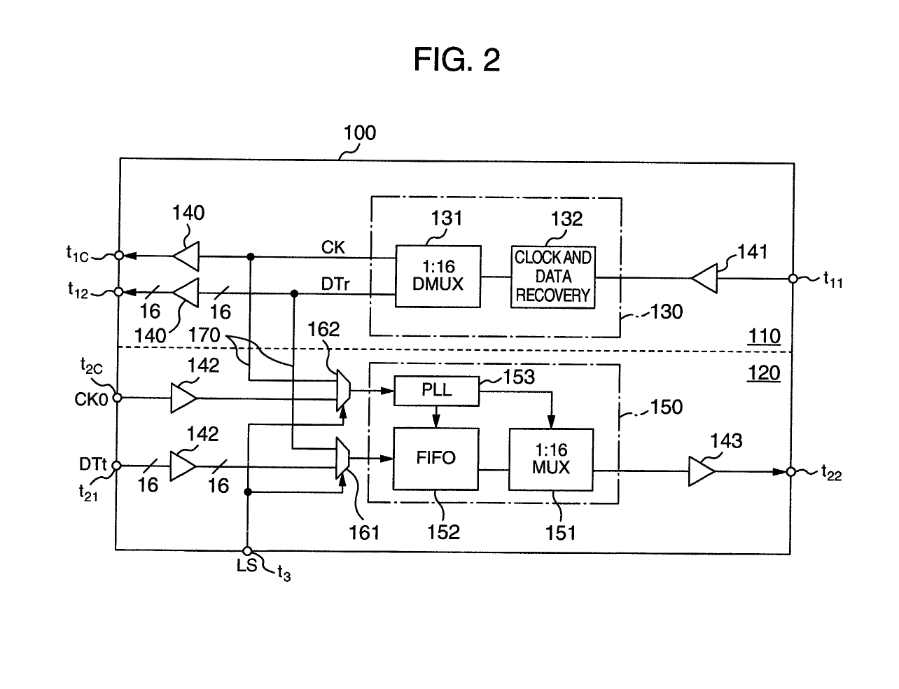

FIG. 2 is a block diagram showing the structure of a transceiver IC for optical communication as an embodiment of a semiconductor integrated circuit according to the invention. Referring to FIG. 2, there is shown a transceiver IC 100, which is a semiconductor integrated circuit having both receiving circuit unit 110 and transmitting circuit unit 120 implemented in a single semiconductor substrate (semiconductor chip). The receiving circuit unit 110 has a signal reception process circuit 130, which converts a multiplex electrical input signal (serial signal) fed from an input port t₁₁ into electrical output (serial) signals on the respective channels, and sends them to an output port t₁₂. The transmitting circuit unit 120 has a signal transmission process circuit 150, by which the electrical signals (serial signals) fed on a plurality of channels from an input port t₂₁ are multiplexed in a time sharing manner to be a multiplex fast electrical output (serial) signal, and sent to an output port t₂₂. At the output ends of the receiving circuit unit 110 and transmitting circuit unit 120, there are respectively provided output buffer circuits 140 and 143 that convert the output signals into signals of desired amplitude levels. At the input ends thereof, there are respectively provided input buffer circuits 141 and 142 that amplify the input signals into signals of desired levels and shape the waves of the signals.

In addition, the transceiver IC 100 of this embodiment has a loopback path 170 connected between the output and input of the receiving circuit unit 110 and transmitting circuit unit 120 so that part of each of the separated electrical signals can be taken out from the signal reception process circuit 130 of the receiving circuit unit 110 and fed back to the signal transmission process circuit 150 of the transmitting circuit unit 120. That is, the loopback path 170 is connected between the junction of the output buffer 140 and the signal reception process circuit 130 and the junction of the input buffer 142 and the signal transmission process circuit 150. The signals transferred via the loopback path 170 may include the clock signal CK recovered from the received signal in addition to the data signal DTr separated on the respective channels.

Moreover, selectors 161, 162 are provided before the signal transmission process circuit 150 of the transmitting circuit unit 120 so that a test mode signal LS from a switch port t₃ can decide if any ones of the signals DTr, CK from the loopback path 170, and a reference clock CK0 from a reference clock port t_{2c}, the electrical data input signal DTt from the input port t₂₁ are selected and fed to the input of the signal transmission process circuit 150. The selector 161 is provided for the selection of either one of the data signals DTr, DTt, and the other selector 162 for either one of the clock signals CK, CK0. These selectors 161, 162 are simultaneously controlled by the test mode signal LS fed via the switch port t₃.

The signal reception process circuit 130 of the receiving circuit unit 110 has a CDR (Clock and Data Recovery) circuit 132 that shapes the waveform of the received multiplex electrical input signal, and generates the clock signal CK on the basis of the change of the multiplex electrical input signal, and a demultiplexer 131 that separates the multiplex, for example, 16-channel, received data signal into data signals on the respective channels. The CDR circuit 132 has, though not shown, a receiving PLL (Phase-Locked Loop) circuit that generates the clock with a stable frequency on the basis of a reference clock extracted from the electrical input signal, and supplies it to the demultiplexer 131.

The signal transmission process circuit 150 of the transmitting circuit unit 120 has a structure such that the data signals of 16 channels of which the transfer rates are each, for example, 622 Mb/s can be multiplexed into a multiplex data signal of 10 GHz and transmitted. The signal transmission process circuit 150 has a buffer memory 152 of FIFO (First-In First-Out) type provided at the data input stage in order to prevent the input clock for data import from causing erroneous operation by jitter, (or in order to absorb the irregularity of the data signal timing). In addition, the buffer memory 152 is followed by a multiplexer 151 that multiplexes the (clocked) data signals of, for example, 16 channels and 622 MHz synchronized with the clock into a data signal of 10 GHz. The buffer memory 152 and multiplexer 151 are supplied with a clock with a stable frequency that a transmitting PLL circuit 153 generates on the basis of a reference clock such as the clock CK0 fed from the reference clock port t_{2c} of the clock CK that the signal reception process circuit 130 extracts from the received data and supplies.

In this transceiver IC of this embodiment, the multiplex electrical input signal fed to the receiving circuit unit 110 via the input port t₁₁ is separated into electrical signals on a plurality of channels by the signal reception process circuit 130, and fed via the output buffer circuit 140 to the output port t₁₂. The electrical input signals on a plurality of channels fed via the input port t₂₁ to the transmitting circuit unit 120 are multiplexed in a time sharing manner by the signal transmission process circuit 150 and supplied to the output port t₂₂. Here, in the normal operation mode, the selectors 161, 162 are controlled by, for example, low level of the test mode signal LS fed via the switch port t₃ to supply the signals held by the input buffers 142 to the signal transmission process circuit 150.

When the operation test is performed, (or in the test operation mode), the signal LS is turned high level, thus controlling the selectors 161, 162 to allow the signals CK, DTr from the loopback path 170 to be supplied to the signal transmission process circuit 150. Therefore, the plurality of electrical channel signals separated by the signal reception process circuit 130 are fed via the loopback path 170 directly to the signal transmission process circuit 150, which then multiplexes them in a time sharing manner, and sends the multiplex signal via the output buffer 143 to the output port t₂₂.

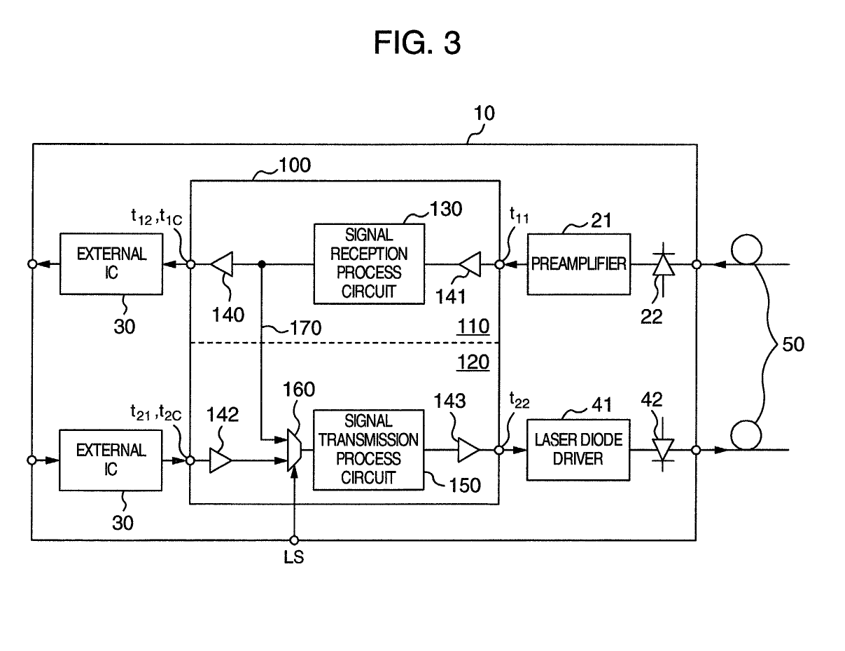

FIG. 3 is a block diagram briefly showing the structure of an optical communication module having the IC 100 of FIG. 2 provided for optical communication. In this figure, the selectors 161, 162 of transceiver IC 100 of FIG. 2 are indicated as a single selector 160, and the transmitting PLL 153 is not shown.

This optical communication module 10 includes the transceiver IC 100, an opto-electrical conversion unit having a photodiode 22 and a preamplifier 21, an electro-optical conversion unit having an LD driver 41 and a laser diode 42, and discrete ICs 30 for lower-speed communication than the circuits 130, 150.

In this optical communication module 10, the multiplex optical input signal received from an optical fiber 50 is converted into a multiplex electrical signal by the photodiode 22, amplified by the preamplifier 21, and fed to the receiving circuit unit 110 of the transceiver IC 100. The multiplex electrical input signal fed to the receiving circuit unit 110 is supplied via the input buffer circuit 141 to the signal reception process circuit 130 where it is separated into data signals on the respective channels. Then, the data signals are fed via the output buffer circuit 140 to the communication IC 30 which then supplies them to, for example, the respective apparatus for communications.

The data signals supplied from a plurality of external apparatus for communications are fed via the communication IC 30 to the input port t₂₁ of the transceiver IC 100. The data signals of a plurality of channels fed to the IC 100 are stored in the input buffer circuit 142 of the transmitting circuit unit 120, and multiplexed in a time sharing manner into a single signal by the transmission process circuit 150. Then, the multiplex signal is fed via the output buffer circuit 143 and via the output port t₂₂ to the LD driver 41. The laser diode 42 converts this multiplex electrical signal into a multiplex optical output signal, and supplies it to the optical fiber 50. At this time, by the low level of the test mode signal LS fed via the switch port t₃, the selector 160 is controlled to supply the signal held by the input buffer 142 to the signal transmission process circuit 150.

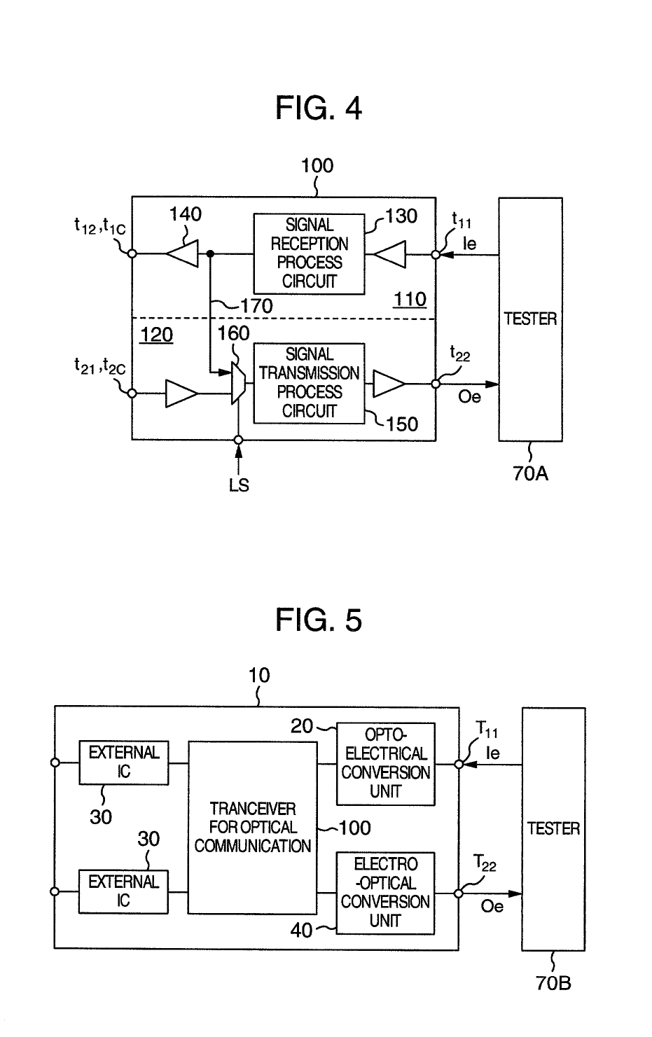

FIG. 4 is a block diagram showing an example of the arrangement for testing the transceiver IC of FIG. 2.

When the transceiver IC 100 itself is tested, a tester 70A is connected to the input port t₁₁ of the receiving circuit unit 110 of the transceiver IC 100 and to the output port t₂₂ of the transmitting circuit unit 120. In addition, the test mode signal LS is supplied to the switch port t₃ of the transceiver IC 100, thus controlling the selector 160 so that the signal from the loopback path 170 can be fed back to the signal transmission process circuit 150.

Under this condition, when an electrical test signal Ie is supplied from the tester 70A to the input port t₁₁ of the receiving circuit unit 110, an electrical response signal Oe can be obtained from the output port t₂₂ of the transmitting circuit unit 120, thus the test being made. In other words, when the electrical test signal Ie is supplied from the tester 70A to the input port t₁₁ of the receiving circuit unit 110, this electrical test signal is fed via the loopback path 170 to the transmitting circuit unit 120, and the electrical response signal Oe is produced from the output terminal t₂₂ of the transmitting circuit unit 120. At this time, by examining the correlation between the input electrical test signal Ie and the produced electrical response signal Oe, it is possible to test the operation of the transceiver IC 100 with ease.

The tester 70A includes a pulse pattern generator for generating the electrical test signal Ie and an error detector for receiving the electrical response signal Oe and detecting an error which may be contained in the electrical response signal Oe. Such a tester is manufactured, for example, by Anritsu Corporation, Atsugi-city, Kanagawa-prefecture, Japan.

FIG. 5 is a block diagram showing an example of the arrangement for testing the optical communication module of FIG. 3.

To make the operation test for the optical communication module 10, a tester 70B is connected to the input and output terminals T₁₁ and T₁₂ of the optical communication module 10 on the side the optical fiber is connected. In addition, as in the operation test for the transceiver IC 100, the selector 160 of the transceiver IC 100 is controlled by the test mode signal LS so that the signal from the loopback path 170 can be supplied to the signal transmission process circuit 150. Then, the tester 70B supplies an optical test signal Ip to the input terminal T₁₁, and receives an optical response signal Op from the module 10, thus making the test. In other words, when the optical test signal Ip is supplied from the tester 70 to the input terminal T₁₁, this optical signal is converted into an electrical signal by the opto-electrical conversion unit 20, fed to the transceiver IC 100, produced via the loopback path of the transceiver IC 100, and converted into the optical signal Op by the electro-optical conversion unit 40. At this time, the operation of the optical communication module 10 can be tested easily by examining the correlation between the optical test signal Ip and the optical response signal Op.

The tester 70B includes, in addition to a pulse pattern generator and an error detector similar to those constituting the tester 70A, a converter for converting an electrical signal from the generator to the optical test signal Ip and another converter for converting the optical response signal Op to an electrical signal. Such a tester is also manufactured, for example, by Anritsu Corporation, Atsugi-city, Kanagawa-prefecture, Japan.

By making the operation tests for both the transceiver IC 100 itself and the optical communication module 10, it is possible to evaluate the opto-electrical conversion unit 20 and electro-optical conversion unit 40 of the optical communication module.

While one embodiment of the invention has been described above in detail, the invention is not limited to the above embodiment.

For example, while the loopback paths and selectors are provided so that both the data signal and the clock signal can be fed back, only the loopback and selector for the data signal to be fed back may be provided with the loopback path for the clock being omitted. In addition, the frequency and channel number of the signals that are supplied to and produced from the IC transceiver IC 100 are not limited, but may be changed variously.

According to the above embodiment, since the transmitting circuit unit and receiving circuit unit are provided on a single semiconductor substrate so as to form the semiconductor integrated circuit for optical communication, the operation test for single IC can be easily performed, and there is no need to provide wiring conductors for connecting each of the ICs such as the transmitting circuit unit and receiving circuit unit as in the prior art.

Moreover, the receiving circuit unit has the output buffer circuit provided for supplying the signals to the outside, and the transmitting circuit unit has the input buffer circuit provided for holding a plurality of channel signals from the outside, while the loopback path is provided on the receiving circuit unit and transmitting circuit unit side rather than the output buffer circuit and input buffer circuit side. Therefore, the output signals from the receiving circuit unit can be transmitted to the transmitting circuit unit without considering the interface specification of the transmitting and receiving IC, or the signal amplitude levels, and thus the loopback path can be designed with ease.

Furthermore, according to the optical communication module with the above semiconductor integrated circuit mounted, the operation of the module can be easily confirmed by only comparing the input signal incident to the optical module from the optical fiber with the output signal supplied from the optical module to the optical fiber, and also the ICs other than the transceiver IC, such as the electro-optical conversion unit, can be adjusted with ease.

What is claimed is:

1. A semiconductor integrated circuit comprising:
a receiving circuit unit for separating a multiplex electrical input signal from a first input port into electrical channel signals on a plurality of channels, delivering said separated electrical channel signals to a first output port, and generating a clock signal from said multiplex electrical input signal;
a loopback path for taking out part of each of said separated electrical channel signals from said receiving circuit unit;
a selector for receiving each of said separated electrical channel signals via said loopback path and a plurality of input electrical channel signals fed from a second input port, and selecting said separated electrical channel signals from said second input port or said input electrical channel signals from said loopback path depending on a test mode signal fed from a switch port; and
a transmitting circuit unit for multiplexing an output from said selector in a time sharing manner to produce a multiplex electrical output signal, and delivering said output signal to a second output port, said receiving circuit unit, said loopback path, said selector and said transmitting circuit unit being formed on a single semiconductor chip, whereby said semiconductor integrated circuit can be tested in a test mode.

2. A semiconductor integrated circuit according to claim 1, further comprising:
another loopback path for taking out part of said clock signal generated from said receiving circuit unit; and
another selector for receiving said generated clock signal via said other loopback path and a reference clock signal from a reference clock port, and selecting said generated clock signal from said other loopback path or said reference clock signal from said reference clock port depending on said test mode signal fed from said switch port, said other loopback path and said other selector being formed on said single semiconductor chip.

3. A semiconductor integrated circuit according to claim 2, wherein said transmitting circuit unit includes:
a clock generation circuit for generating an operation clock signal on the basis of said generated clock signal from said other selector;
a first-in first-out type buffer arranged to operate in synchronism with said operation clock signal from said clock generation circuit in order to absorb differences between timing change in said plurality of electrical input signals fed from said second input port; and
a multiplexer for multiplexing said plurality of clocked electrical signals from said buffer in a time sharing manner.

4. A semiconductor integrated circuit according to claim 3, further comprising:
an output buffer connected between said first output port and said receiving circuit unit; and
an input buffer connected between said second input port and said transmitting circuit unit, said output buffer and said input buffer being formed on said semiconductor chip, said two loopback paths being both connected between a junction of said output buffer and said receiving circuit unit and a junction of said input buffer and said transmitting circuit unit.

5. An optical communication module comprising:
an opto-electrical conversion unit for converting a multiplex optical input signal from an optical fiber into a multiplex electrical input signal;
a semiconductor integrated circuit including a receiving circuit unit for receiving said multiplex electrical input signal via a first input port, separating said input signal into electrical channel signals on a plurality of channels, delivering said separated electrical channel signals to a first output port, and generating a clock signal from said multiplex electrical input signal, a loopback path for taking out part of each of said separated electrical channel signals from said receiving circuit unit, a selector for receiving said separated electrical channel signals via said loopback path and a plurality of input electrical signals fed from a second input port, and selecting said separated electrical channel signals from said second input port or said input electrical channel signals from said loopback path depending on a test mode signal fed from a switch port, and a transmitting circuit unit for multiplexing an output from said selector in a time sharing manner into a multiplex electrical output signal, and delivering said output signal to a second output port, said opto-electrical conversion unit, said receiving circuit unit, said loopback path, said selector, and said transmitting circuit unit being formed on a single semiconductor chip;
an electro-optical conversion unit for converting said multiplex electrical output signal fed from said second output port of said semiconductor integrated circuit into a multiplex optical output signal, whereby said optical communication module can be tested in a test mode.

6. A semiconductor integrated circuit having a transceiver comprising:
a first input port for receiving a multiplex electrical input signal;
a plurality of second input ports for receiving a plurality of electrical data input signals;
a switch port for receiving a test mode signal;
a receiving circuit unit having a function to separate said multiplex electrical input signal received via said first input port to produce a plurality of data signals;
a plurality of first output ports for delivering said plurality of data signals produced from said receiving circuit unit;
a loopback path with one end coupled to an output of said receiving circuit unit;
a selector arranged to be controlled by said test mode signal fed via said switch port, to receive said plurality of electrical data input signals via said plurality of second input ports, to be connected to another end of said loopback path to receive said plurality of data signals generated from said receiving circuit unit, to normally select said plurality of electrical data input signals from said plurality of second input ports, and when receiving said test mode signal via said switch port, to select said plurality of data signals generated from said receiving circuit unit;
a transmitting circuit unit having a function to multiplex electrical data signals selected by said selector to produce a multiplex electrical output signal; and
a second output port for delivering said multiplex electrical output signal generated from said transmitting circuit unit, said first input port, said plurality of second input ports, said switch port, said receiving circuit unit, said plurality of first output ports, said loopback path, said selector, said transmitting circuit unit and said second output port being formed on a single semiconductor chip, whereby said transceiver can be tested in a test mode.

7. An optical communication module comprising:
a converter for converting a multiplex optical input signal into a multiplex electrical input signal;
a transceiver having a first input port for receiving said multiplex electrical input signal, a plurality of second input ports for receiving a plurality of electrical data input signals, a switch port for receiving a test mode signal, a receiving circuit unit having a function to separate said multiplex electrical input signal received via said first input port into a plurality of data signals to generate said plurality of data signals, a plurality of first output ports for delivering said plurality of data signals generated from said receiving circuit unit, a loopback path with one end coupled to an output of said receiving circuit unit, a selector arranged to be controlled by said test mode signal via said switch port, to receive said plurality of electrical input signals via said plurality of second input ports, to be connected to another end of said loopback path to receive said plurality of data signals generated from said receiving circuit unit, to normally select said plurality of data input signals from said plurality of second input ports, and when receiving said test mode signal via said switch port, to select said plurality of data signals generated from said receiving circuit unit, a transmitting circuit unit having a function to multiplex electrical data signals selected by said selector to generate a multiplex electrical output signal, and a second output port for delivering said multiplex electrical output signal generated from said transmitting circuit unit, said first input port, said plurality of second input ports, said switch port, said receiving circuit unit, said plurality of first output ports, said loopback path, said selector, said transmitting circuit unit and said second output port being formed on a single semiconductor chip; and
another converter for converting said multiplex electrical output signal from said second output port of said transceiver into a multiplex optical output signal, whereby said optical communication module can be tested in a test mode.
